(19) United States
(12) Patent Application Publication
(10) Pub. No.: US 2012/0248656 A1
(43) Pub. Date: Oct. 4, 2012

(54) METHOD OF MANUFACTURING THERMOSETTING SOLUTION AND METHOD OF MANUFACTURING TUBULAR MEMBER

(75) Inventors: Yuki MITANI, Kanagawa (JP); Masayuki SEKO, Kanagawa (JP); Toshikazu OHNO, Kanagawa (JP); Yuichi YASHIKI, Kanagawa (JP)

(73) Assignee: FUJI XEROX CO., LTD., Tokyo (JP)

(21) Appl. No.: 13/357,124

(22) Filed: Jan. 24, 2012

(30) Foreign Application Priority Data
Mar. 28, 2011 (JP) 2011-070886

(51) Int. Cl. B29C 39/14; H01B 1/12

(52) U.S. Cl. 264/331.12; 252/500

(57) ABSTRACT

A method of manufacturing a thermosetting solution includes a process for preparing a solution having a conductive material having an acid group dispersed in the solution, preparing a polyimide precursor solution, and mixing the solution having the conductive material dispersed therein and the polyimide precursor solution, and stirring the mixed solution using a stirring tank in which a stirring blade is disposed and the minimum gap between the inner surface of the stirring tank and the stirring blade is from about 1 mm to about 15 mm.

### CROSS-REFERENCE TO RELATED APPLICATIONS

This application is based on and claims priority under 35 USC 119 from Japanese Patent Application No. 2011-070886 filed Mar. 28, 2011.

### BACKGROUND

1. Technical Field

The present invention relates to a method of manufacturing a thermosetting solution and a method of manufacturing a tubular member.

2. Related Art

There are cases in which a tubular member that is used in an electrophotographic image-forming apparatus or the like is required to have strength or dimensional stability. In addition, it is known that a tubular member is configured to include an electrically conductive material in order to be applied to a variety of apparatuses that employ electrophotographic method.

### SUMMARY

According to an aspect of the invention, there is provided a method of manufacturing a thermosetting solution including:

preparing a solution having a conductive material having an acid group dispersed in the solution;

preparing a polyimide precursor solution; and

mixing the solution having the conductive material dispersed therein and the polyimide precursor solution, and

stirring the mixed solution using a stirring tank in which a stirring blade is disposed and the minimum gap between the inner surface of the stirring tank and the stirring blade is from about 1 mm to about 15 mm.

### BRIEF DESCRIPTION OF THE DRAWINGS

Exemplary embodiments of the present invention will be described in detail based on the following figures, wherein:

FIG. 1 is a cross-sectional view of the stirring apparatus used in the present exemplary embodiment;

FIG. 2 is a schematic view showing an example of the film-forming apparatus that is used in the method of manufacturing a tubular member in the exemplary embodiment;

FIG. 3 is a schematic view showing an example of the film-forming apparatus that is used in the method of manufacturing a tubular member in the exemplary embodiment;

FIG. 4 is a schematic view showing a state in which a coated film or a tubular member is formed on a core member; and

FIGS. 5A and 5B are schematic views showing an example of a volume resistivity-measuring apparatus for measuring the volume resistivity of a tubular member, in which FIG. 5B is a planar view, and FIG. 5A is a cross-sectional view taken along the line A-A′ in FIG. 5B.

### DETAILED DESCRIPTION

Hereinafter, an exemplary embodiment of the method of manufacturing a thermosetting solution according to the exemplary embodiment will be described.

The method of manufacturing a thermosetting solution according to the exemplary embodiment has (1) a process for preparing a solution having a conductive material having an acid group dispersed in the solution, a process for preparing a polyimide precursor solution (hereinafter the processes in which the solution having a conductive material dispersed therein and the polyimide precursor solution are prepared will be referred to collectively as the “preparation process”), and (2) a process for mixing the solution having the conductive material dispersed therein and the polyimide precursor solution, and stirring the mixed solution using a stirring tank in which a stirring blade is disposed, and the minimum gap between the inner surface of the stirring tank and the stirring blade is from 1 mm to 15 mm (or from about 1 mm to about 15 mm) (hereinafter referred to as the “stirring process”).

Here, while it is desirable that the volume resistivity of a compact that is formed using a thermosetting solution be not varied during the manufacturing of the compact, in a case in which the compact is formed using a thermosetting solution manufactured by a manufacturing method not having the preparation process and the stirring process, the volume resistivity of the manufactured compact is varied even when the content of the conductive material having an acid group and the content of the polyimide precursor solution are the same.

The variation in the volume resistivity of the compact that is molded using the thermosetting solution manufactured by a manufacturing method not having the preparation process and the stirring process is considered to result from the following phenomenon.

That is, while a dissociation reaction and a binding reaction occur in molecules of the polyimide precursor (polyamic acid), it is considered that the rate of the dissociation reaction is varied by a mechanical stress applied to the thermosetting solution during the stirring process, the dissociation reaction does not advance easily in a case in which the stress applied to the thermosetting solution is weak, and, when the dissociation reaction advances during the holding time, the interaction (reaction) between the base in the polyimide precursor and the acid group in the conductive material having an acid group gradually varies the dispersion state of the conductive material having an acid group in the thermosetting solution.

Therefore, in a case in which the mechanical stress applied to the thermosetting solution is weak during the stirring process, it is considered that the advancement degree of the interaction is varied depending on the holding time of the thermosetting solution, and variation in the volume resistivity of the manufactured compact occurs.

In addition, it is considered that the mechanical stress applied to the thermosetting solution is varied during the stirring process such that the advancement of wetting of the conductive material is varied. It is considered that, when the mechanical stress is weak, wetting of the conductive material does not advance easily, the dissociation reaction of the polyimide precursor in the thermosetting solution advances during the holding time, and at the same time, the interaction between the base in the polyimide precursor and the acid group in the conductive material having an acid group and the wetting of the conductive material advances, and the dispersion state is varied.

Therefore, it is considered that, in the stirring process, in a case in which the mechanical stress is weak during stirring in the stirring process, the advancement degree of the interaction is varied depending on the holding time of the thermosetting solution, and variation in the volume resistivity of the manufactured compact occurs.

Therefore, in the exemplary embodiment, a strong mechanical stress is added using a stirring tank in which stirring blade is disposed, and the minimum gap between the inner surface of the stirring tank and the stirring blade is from 1 mm to 15 mm. It is considered that doing the above promotes the dissociation reaction among polyimide precursor molecules during the stirring process, and promotes the interaction between the base in the polyimide precursor and the acid group of the conductive material. Alternately, it is considered that the wetting of the conductive material having an acid group is promoted, and the interaction between the base in the polyimide precursor and the acid group of the conductive material is promoted. Therefore, it is considered that variation in the degree of the interaction during the holding time between the base in the polyimide precursor and the acid group of the conductive material having an acid group becomes gentle.

As a result, the thermosetting solution that has undergone the stirring process according to the exemplary embodiment suppresses variation in the volume resistivity of the compact, which results from difference in the holding time after the manufacturing.

Hereinafter, the methods of manufacturing a thermosetting solution and a compact, and a material used in the manufacturing will be described in detail.

(Preparation Process)

The solution having the conductive material dispersed therein is adjusted by, for example, dispersing a conductive material having an acid group in an organic solvent, such as N-methyl pyrrolidone. Meanwhile, a polyimide precursor may be dissolved in the solution having the conductive material dispersed therein, or a conductive material may be dispersed in a solution having the polyimide precursor dissolved therein. Examples of the dispersing method include ball mill, sand mill, beads mill, jet mill (opposed impact-type disperser), and the like.

In all cases in which any of the dispersing methods is used, the viscosity of the solution (the solution including the conductive material having an acid group and the polyimide precursor solution) during the dispersion is desirably from 1 Pa·s to 50 Pa·s from the viewpoint of improvement in the dispersibility.

Methods of maintaining the viscosity in a case in which the polyimide precursor is dissolved in the solution having the conductive material dispersed therein include a method of adjusting the temperature of the solution during the dispersion. Specifically, it is desirable to, for example, adjust the temperature of the solution to 50° C. or higher during the dispersion.

Meanwhile, the temperature of the solution may be increased during the dispersion by, for example, using heat generated by mechanical energy during the dispersion or adding heat to a container used during the dispersion.

The concentration of the conductive material during the dispersion is, for example, desirably from 50% by mass to 200% by mass with respect to the solid content mass of the solution in a case in which the conductive material is dispersed in the polyimide precursor solution. This is because, since there are cases in which it takes time to disperse the conductive material, it is considered to be efficient to disperse the conductive material at a high concentration by reducing the amount of a liquid.

The polyimide precursor is obtained by causing a reaction between a tetracarboxylic dianhydride and a diamine component in a solvent. The kind of the polyimide precursor is not particularly limited, but an aromatic polyimide precursor obtained by causing a reaction between an aromatic tetracarboxylic dianhydride and an aromatic diamine component is desirable from the standpoint of the strength.

Representative examples of the aromatic tetracarboxylic acids include pyromellitic dianhydrides, 3,3′,4,4′-biphenyl tetracarboxylic dianhydride, 3,3′,4,4′-benzophenone tetracarboxylic dianhydride, 2,3,4,4′-biphenyl tetracarboxylic dianhydride, 2,3,6,7-naphthalene tetracarboxylic dianhydride, 1,2,5,6-naphthalene tetracarboxylic dianhydride, 2,2-bis(3,4-dicarboxy phenyl)ether dianhydride, tetracarboxylic esters thereof, mixtures of the above tetracarboxylic acids, and the like.

Meanwhile, the aromatic diamine component includes paraphenylenediamine, metha-Phenylene diamine, 4,4′-diaminodiphenyl ether, 4,4′-diaminophenyl methane, benzidine, 3,3′-dimethoxy benzidine, 4,4′-diaminodiphenyl propane, 2,2-bis[4-(4-aminophenoxy)phenyl]propane, and the like.

In addition, in order to improve adhesiveness between a forming polyimide layer and a metal layer, as described in JP-A-2003-136632, a PI-silica hybrid member having an alkoxysilane compound combined to polyimide (PI) may be used.

In the solution having a conductive material dispersed therein, the viscosity and concentration of the conductive material are adjusted according to purpose. For example, a desirable solid content concentration of the polyimide precursor solution having the conductive material dispersed therein is from 10% by mass to 40% by mass. In addition, a desirable viscosity of the polyimide precursor solution having the conductive material dispersed therein is, for example, from 1 Pa·s to 50 Pa·s.

Examples of the conductive material include carbon-based substances having an acid group (carbon black, carbon fiber, carbon nanotube, graphite, and the like) and whiskers having an acid group (conductive metal oxides, such as tin oxide, indium oxide, and antimony oxide; potassium titanate; and the like). Among them, carbon black is desirably used.

Examples of the acid group included in the conductive material include a carboxylic group, a quinone group, a lactone group, a hydroxyl group, and the like. It is considered that the conductive material has the acid group so that the dispersibility in the solution becomes favorable, and the dispersion stability is obtained.

The conductive material having an acid group is obtained by, for example, subjecting the above conductive material to an oxidizing treatment. Examples of the oxidizing treatment method of the conductive material include an air oxidation method in which the conductive material is brought into contact with air at a high temperature (for example, 800° C. or higher) so as to cause a reaction, a method in which the conductive material is reacted with a nitrogen oxide or ozone at room temperature (for example, 30° C.), a method in which the conductive material is oxidized by air at a high temperature, and oxidized by ozone at a low temperature (for example, 20° C. or lower), a contacting method, and the like.

Examples of the contacting method include a channel method, a gas black method, and the like. In addition, the conductive material having an acid group may also be manufactured by, for example, the furnace black method in which a gas or an oil is used as a raw material. Furthermore, a liquid-phase oxidizing treatment in which a nitric acid is used may be carried out after the above treatment according to necessity.

The pH value of the conductive material having an acid group may be any value; however, for example, is desirably 5.0 or less, more desirably 4.5 or less, and further desirably 4.0 or less.

The pH of the conductive material having an acid group, which is dispersed in the polyimide precursor solution, is obtained by adjusting an aqueous suspension and measuring the pH using glass electrodes. In addition, the pH of the conductive material having an acid group is adjusted depending on conditions, such as treatment temperature and treatment time, of the oxidizing treatment process.

Specifically, the conductive material having an acid group includes “PRINTER 150T,” manufactured by Evonik Industries AG, (pH 4.5, volatile content 10.0%), “SPECIAL BLACK 350,” manufactured by Evonik Industries AG, (pH 3.5, volatile content 2.2%), “SPECIAL BLACK 100,” manufactured by Evonik Industries AG, (pH 3.3, volatile content 2.2%), “SPECIAL BLACK 250,” manufactured by Evonik Industries AG, (pH 3.1, volatile content 2.0%), “SPECIAL BLACK 5,” manufactured by Evonik Industries AG, (pH 3.0, volatile content 15.0%), “SPECIAL BLACK 4,” manufactured by Evonik Industries AG, (pH 3.0, volatile content 14.0%), “SPECIAL BLACK 4A,” manufactured by Evonik Industries AG, (pH 3.0, volatile content 14.0%), “SPECIAL BLACK 550,” manufactured by Evonik Industries AG, (pH 2.8, volatile content 2.5%), “SPECIAL BLACK 6,” manufactured by Evonik Industries AG, (pH 2.5, volatile content 18.0%), “COLOR BLACK FW200,” manufactured by Evonik Industries AG, (pH 2.5, volatile content 20.0%), “COLOR BLACK FW2,” manufactured by Evonik Industries AG, (pH 2.5, volatile content 16.5%), “COLOR BLACK FW2V,” manufactured by Evonik Industries AG, (pH 2.5, volatile content 16.5%), “MONARCH1000,” manufactured by Cabot Corporation, (pH 2.5, volatile content 9.5%), “MONARCH1300,” manufactured by Cabot Corporation, (pH 2.5, volatile content 9.5%), “MONARCH1400,” manufactured by Cabot Corporation, (pH 2.5, volatile content 9.0%), “MOGUL-L,” manufactured by Cabot Corporation, (pH 2.5, volatile content 5.0%), “REGAL400R,” manufactured by Cabot Corporation, (pH 4.0, volatile content 3.5%), and the like.

The polyimide precursor solution for being mixed in the solution having the conductive material dispersed therein is prepared by dissolving the above polyimide precursor in a solvent. Meanwhile, the method of preparing the polyimide precursor solution is not limited to the above, and, as long as the polyimide precursor is dissolved in a solution having the conductive material dispersed therein, the kind and molecular weight of the polyimide precursor, and the concentration of the conductive material may be different from the above.

(Mixing Process, Stirring Process)

The solution having the conductive material dispersed therein and the polyimide precursor solution are mixed. Thereby, for example, the concentration of the conductive material or the viscosity is adjusted in the mixing process.

In a case in which adjustment of the concentration of the conductive material is carried out, for example, a solution having a small concentration of the conductive material is applied to the solution having the conductive material dispersed therein. At this time, the concentration of the conductive material after the adjustment is, for example, desirably from 10% by mass to 35% by mass with respect to the solid content mass of the polyimide precursor solution.

In addition, in a case in which adjustment of the viscosity is carried out, for example, a polyimide precursor solution having a higher molecular weight than the polyimide precursor is applied in a case in which the polyimide precursor is dissolved in a solution having the conductive material dispersed therein as the polyimide precursor solution. Here, the viscosity of the solution having the conductive material dispersed therein is, for example, from 10 Pa·s to 40 Pa·s, and the viscosity of the polyimide precursor solution is, for example, desirably from 10 Pa·s to 100 Pa·s. In addition, the limiting viscosity of the polyimide precursor solution is desirably 40 ml/g or less.

Meanwhile, in a case in which the solution having the conductive material dispersed therein and the polyimide precursor are mixed, purpose-matched amounts of the solution having the conductive material dispersed therein and the polyimide precursor solution may be added and mixed at once, the polyimide precursor solution may be dropped dropwise into a tank that contains the solution having the conductive material dispersed therein, or, conversely, the solution having the conductive material dispersed therein may be dropped dropwise into a tank that contains the polyimide precursor solution.

In addition, the mixing may be carried out in a stirring tank that is used in the stirring process as described below, or may be carried out separately.

In the stirring process, the mixed solution is stirred using a stirring apparatus 60. Stirring suppresses occurrence of inconsistence in the concentration of the conductive material in the mixed solution.

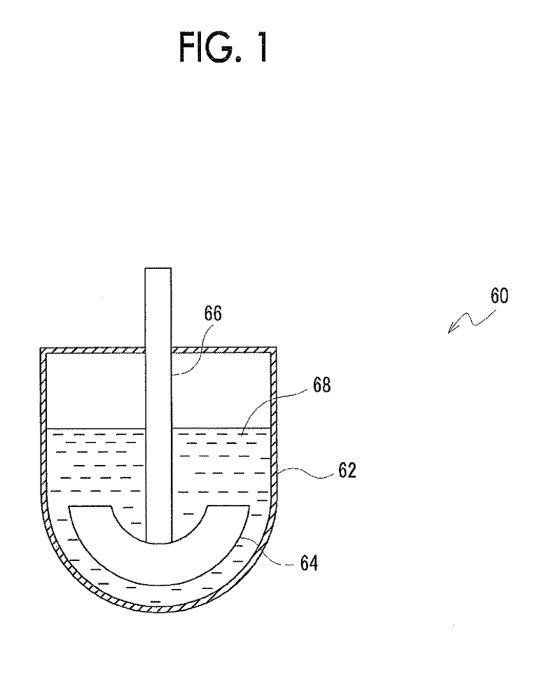

As shown in FIG. 1, the stirring apparatus 60 that is used in the stirring process has, for example, a stirring tank 62 and a stirring blade 64 installed in the stirring tank. The stirring blade 64 is connected to the shaft core 66.

In the stirring apparatus 60, the minimum gap between the stirring blade 64 and the inner surface of the stirring tank 62 is from 1 mm to 15 mm. The gap is desirably from 3 mm to 12 mm, and more desirably from 5 mm to 10 mm.

Meanwhile, when the minimum gap is less than 1 mm, a load applied to the stirring blade 64 is increased such that stirring becomes difficult, and there is a concern that the stirring tank 62 and the stirring blade 64 may be brought into contact with each other. In a case in which the minimum gap exceeds 15 mm, it is considered that the stress becomes weak even when the solution is stirred, and the volume resistivity of the compact becomes liable to be varied due to difference in the holding time of the thermosetting solution after the stirring.

The stirring blade 64 preferably has a minimum gap with the inner surface of the stirring tank 62 in the above range; however, specifically, for example, of the outer surface of a shape drawn by the rotating orbit of the stirring blade 64, 30% or more (or about 30% or more) of the area of the surface facing the inner surface of the stirring tank 62 preferably has a gap between the outer surface of the shape of the stirring blade 64 that faces the inner surface of the stirring tank 62 and the inner surface of the stirring tank 62 in a range of from 1 mm to 15 mm. The gap is desirably from 3 mm to 12 mm, and more desirably from 5 mm to 10 mm.

Thereby, a strong mechanical stress is easily added to the entire mixed solution, and it is considered that variation in the volume resistivity of the compact due to difference in the holding time of the obtained thermosetting solution is suppressed.

Here, the minimum gap between the stirring blade 64 and the inner surface of the stirring tank 62 refers to the shortest distance between the stirring blade 64 and the stirring tank 62 in a position where the stirring blade 64 connected to the shaft core 66 and the inner surface of the stirring tank 62 having the stirring blade 64 installed therein come closest to each other. In a case in which the stirring tank 62 has plural stirring blades 64, such as a stirring tank having two or more shaft cores 66 to which the stirring blades 64 are connected or a stirring tank having two or more stirring blades 64 connected to the shaft core 66, the minimum gap refers to the shortest of the distances from the respective stirring blades 64. In addition, the minimum gap between the stirring blade 64 and the inner surface of the stirring tank 62 may be measured from, for example, a part, such as the front end or edge, of the stirring blade 64.

In summary, the stirring blade 64 is preferably installed with the selected shape and size so that the gap between at least a part of the stirring blade and the inner surface of the stirring tank 62 is in the above range.

The shape drawn by the rotating orbit of the stirring blade 64 refers to a shape shaped by the orbit drawn by the outermost side of the orbit drawn by the contour of the stirring blade 64 when the stirring blade 64 is rotated around the rotating shaft (shaft core 66) or moved together with the rotating shaft. Here, the surface of the outer surface of the shape drawn by the rotating orbit of the stirring blade 64 which faces the inner surface of the stirring tank 62 refers to a surface of the outer surface of the shape which faces the inner surface of the stirring tank 62, and 30% or more of the area refers to an area that occupies 30% or more of the above surface that faces the inner surface of the stirring tank 62.

Examples of the stirring apparatus that satisfies the above stirring conditions include a uniaxial stirring apparatus, a biaxial stirring apparatus, a triaxial stirring apparatus, and the like. Since the respective stirring apparatuses have stirring tanks and stirring blades having various shapes, the stirring apparatus may have any shape as long as the stirring apparatus satisfies the conditions.

The rotating speed (stirring speed) of the stirring blade 64 during the stirring process is desirably, for example, approximately from 10 rpm to 100 rpm. In addition, in a case in which the stirring blade 64 is moved (rotated) together with the rotating shaft, the speed of the stirring blade 64 that moves together with the rotating shaft (shaft core) (hereinafter referred to as the orbit speed) is desirably, for example, from 10 rpm to 50 rpm, and the rotating speed of the stirring blade 64 (hereinafter referred to as the rotation speed) is desirably, for example, from 50 rpm to 200 rpm.

Other stirring conditions of the stirring process will be described.

The temperature of the mixed solution during the stirring process is desirably, for example, 5° C. to 45° C. In a case in which stirring increases the temperature of the mixed solution, it is considered to be effective to cool the stirring tank 62.

The stirring time during the stirring process is preferably, for example, from 10 minutes to 150 minutes.

The stirring process is desirably carried out under vacuum (for example, from −80 kPa to −200 kPa).

The thermosetting solution is prepared through the above processes. The obtained thermosetting solution is used for manufacturing a compact (resin compact), such as a film or a tubular member.

Here, the thermosetting solution obtained by the method of manufacturing a thermosetting solution according to the exemplary embodiment preferably has a limiting viscosity of, for example, 40 ml/g or less (or about 40 ml/g or less). It is considered that setting the limiting viscosity to 40 ml/g or less suppresses steric hindrance during the interaction with the conductive material having an acid group, variation in the relative amount of the interaction between the base in the polyimide resin precursor and the acid group in the conductive material, and, consequently, in a compact formed using a thermosetting solution having the above limiting viscosity, variation in the volume resistivity of the compact due to difference in the holding time of the thermosetting solution is suppressed.

As described above, the limiting viscosity of the thermosetting solution is preferably 40 ml/g or less, more desirably from 5 ml/g to 30 ml/g, and particularly desirably from 5 ml/g to 20 ml/g. It is considered that, in a case in which the limiting viscosity is less than 5 ml/g, there is a tendency for the liquid to flow.

Meanwhile, the limiting viscosity is a value that is measured using an Ubbelohde viscometer, which is a capillary viscometer, according to JIS standard (K-7367-1). It is generally known that the limiting viscosity is positively correlated with the molecular weight as shown in the Mark-Houwink formula, and this method is frequently used as an alternative method for measuring the molecular weight of the polyimide precursor which is highly polar and whose molecular weight is easily varied due to an equilibrium reaction and is not easily measured accurately by a method, such as the gel permeation chromatography (GPC).

(Method of Manufacturing a Tubular Member)

The method of manufacturing a tubular member according to the exemplary embodiment has a process in which a coated film is formed using the thermosetting solution (hereinafter the “coated film-forming process”) and a process in which the coated film is heated and cured (hereinafter the “heating and curing process”). In the present manufacturing method, the thermosetting solution according to the exemplary embodiment is applied.

Hereinafter the respective processes for manufacturing a tubular member will be described.

<Coated Film-Forming Process>

In the coated film-forming process, the thermosetting solution is coated on, or on the inside a core member, and a coated film of the thermosetting solution is formed. Examples of materials of the core member include metal (aluminum, stainless steel, and the like), fluororesin, silicone resin, and metal having the above resin coated on the surface. In a case in which a metal is used for the core member material, for example, chromium or nickel may be plated or a mold release agent may be coated on the surface in advance so that a tubular member formed on the core member is easily taken out from the core member.

Examples of the desirable shape of the core member include a cylindrical shape or a columnar shape.

A method of coating the thermosetting solution on the core member is not particularly limited. Examples of the method include a spin coating method as well as the outer surface coating method as described in JP-A-6-23770, the immersion coating method as described in JP-A-3-180309, the spiral coating method as described in JP-A-9-85756, and the like, and the method is selected according to the shape and size of the core member.

Hereinafter, a case in which the spiral coating method is used as the method of coating the thermosetting solution will be described as an example.

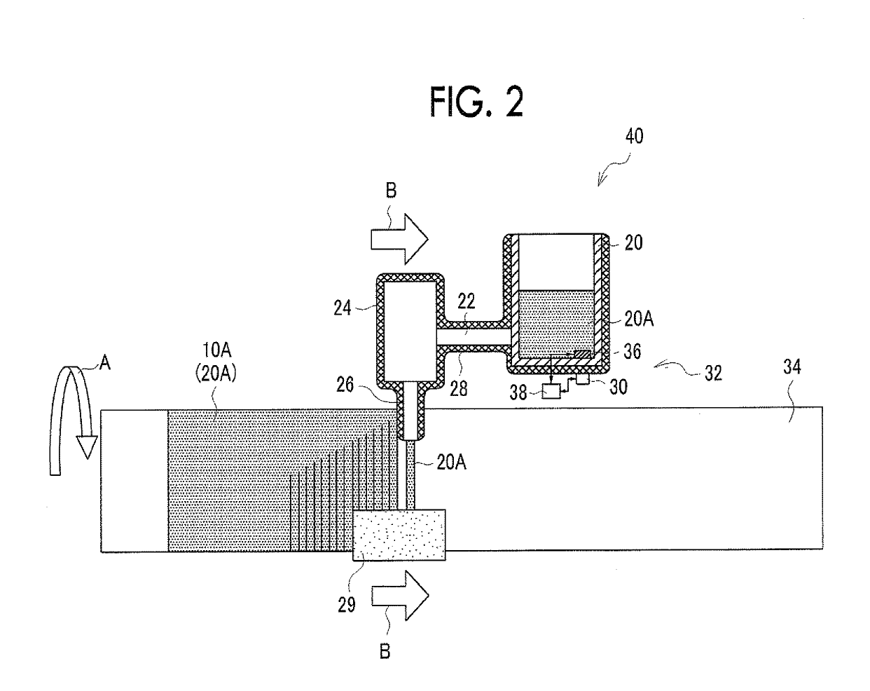

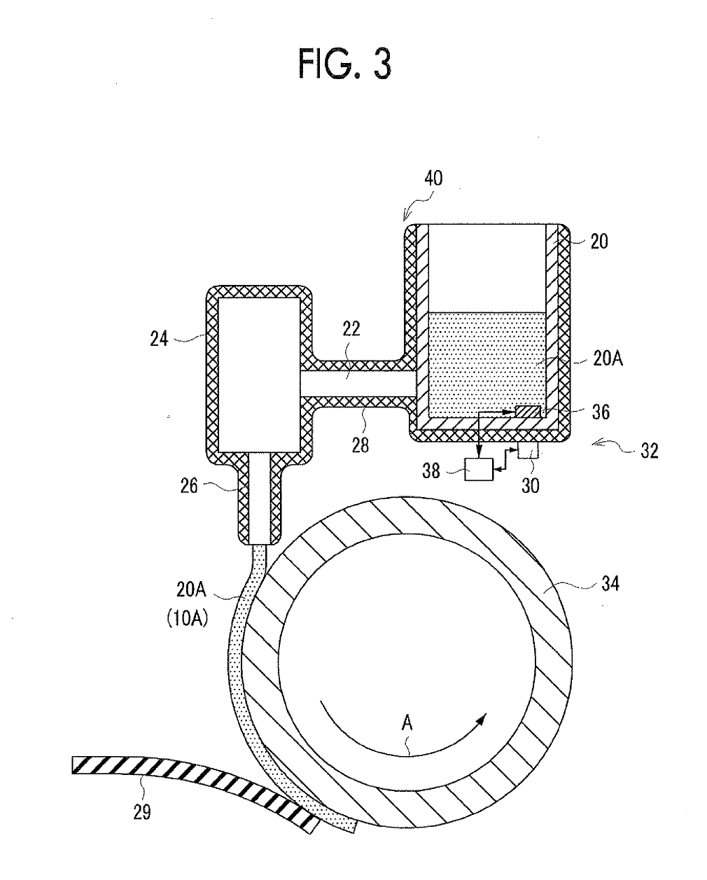

As shown in FIGS. 2 and 3, in the film-forming apparatus 40, a cylindrical core member 34 is rotated in the circumferential direction, a thermosetting solution 20A is coated on the outside surface of the core member 34, and the thermosetting solution is flattened and coated using a blade 29 disposed in contact with the outside surface of the core member 34.

In the film-forming apparatus 40, the thermosetting solution 20A stored in a storage unit 20 is supplied by a pump 24 to the outside surface of the core member 34 that is rotating in the arrow A direction through a supply pipe 22 and a nozzle 26.

The thermosetting solution 20A coated in a linear shape on the outside surface of the core member 34 is flattened using the blade 29. Therefore, it is suppressed for the thermosetting solution 20A to remain in a spiral line on the core member 34, and a coated film 10A is formed. The rotating speed of the core member 34 during the coating is, for example, from 20 rpm to 300 rpm, and the relative moving speed between the nozzle 26 and the core member 34 is, for example, from 0.1 m/minute to 2.0 m/minute.

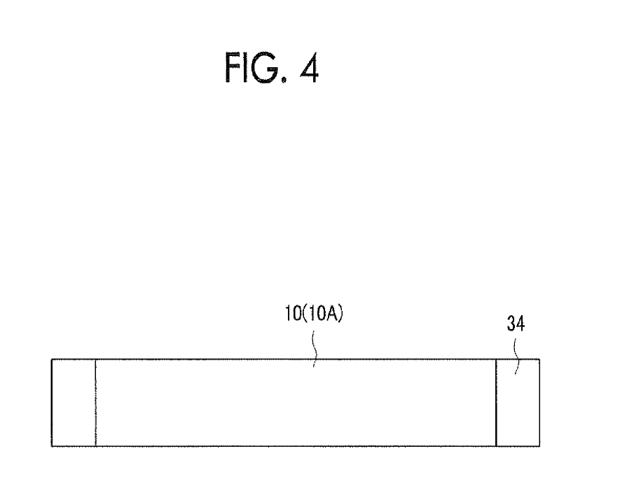

The film-forming apparatus 40 and the core member 34 are relatively moved from one end side to the other end side of the core member 34 in the long direction (refer to the arrow B direction in FIG. 2). Thereby, the coated film 10A of the thermosetting solution 20A is formed on the core member 34 (refer to FIG. 4).

The film-forming apparatus 40 is provided with a temperature-maintaining apparatus 32 for maintaining the target temperature of the thermosetting solution 20A stored in the storage unit 20 or the thermosetting solution 20A flowing in the supply pipe 22, the pump 24, and the nozzle 26. The temperature-maintaining apparatus 32 is just required to have a configuration in which the thermosetting solution 20A stored in the storage unit 20 or the thermosetting solution 20A flowing in the supply pipe 22, the pump 24, and the nozzle 26 is maintained at the target temperature.

For example, the temperature-maintaining apparatus 32 may have a configuration including a heat-retention member 28, a temperature-adjusting apparatus 30, a temperature-measuring apparatus 36, and a control unit 38.

The heat-retention member 28 is a member having a heat-retention function, and is provided so as to cover the outsides of the storage unit 20, the supply pipe 22, the pump 24, and the nozzle 26. A well-known member having a heat-retention function may be used as the heat-retention member 28. The temperature-adjusting apparatus 30 is an apparatus for maintaining the temperature of the inside (that is, the storage unit 20, the supply pipe 22, the pump 24, and the nozzle 26) of the heat-retention member 28 at the target temperature. A well-known apparatus having a function of adjusting the temperature (heating or cooling function) may be used as the temperature-adjusting apparatus 30. The thermosetting solution 20A in the storage unit 20, the supply pipe 22, the pump 24, and the nozzle 26 which are present in the heat-retention member 28 is maintained at the target temperature by the temperature-adjusting apparatus 30 by cooling the inside of the heat-retention member 28 using the temperature-adjusting apparatus 30.

The temperature-measuring apparatus 36 is provided in the storage unit 20 (for example, at the bottom portion inside the storage unit 20), and the temperature of the thermosetting solution 20A stored in the storage unit 20 is measured.

The control unit 38 is electrically connected to the temperature-measuring apparatus 36 and the temperature-adjusting apparatus 30, and controls the temperature-adjusting apparatus 30 based on temperature information received from the temperature-measuring apparatus 36 so that the inside of the heat-retention member 28 is maintained at the target temperature.

<Heating and Curing Process>

Next, the coated film 10A formed in the coated film-forming process is heated and cured (the heating and curing process), but it is desirable to dry or half cure the coated film 10A before this process.

Here, the ‘drying’ refers to heating for vaporizing the solvent included in the thermosetting solution that composes the coated film 10A, and, in practice, the time is set at approximately from 100° C. to 200° C. (for example, from 30 minutes to 60 minutes). In addition, the “half curing” refers to a state in which a part of the coated film is imidized while the imidization reaction of the polyimide resin precursor included in the thermosetting solution does not advance. In practice, for example, when a purpose-matched time is set at approximately from 120° C. to 250° C., the coated film 10A becomes half cured, and has an increased strength compared with the dried state.

While this drying or half curing is carried out at a temperature, a time, and the like, which are set according to the kind of the polyimide resin precursor or the solvent, since there are cases in which the coated film 10A becomes liable to be cracked when the solvent is fully vaporized from the coated film 10A, it is desirable for a certain amount of the solvent to remain (for example, approximately from 5% by mass to 40% by mass).

Meanwhile, a higher temperature shortens the drying time, which is preferable. In addition, it is also desirable to strike hot air during the drying. The temperature may be increased in stages, or increased at a constant rate.

The drying is desirably carried out while the core member 34 is placed so that the shaft direction goes along with the horizontal direction, and rotated at a rotating speed of from 5 rpm to 60 rpm in order to suppress sagging of the coated film 10A. In addition, in the subsequent heating and curing process, it is preferable to carry out heating and curing while the shaft direction of the core member 34 is placed in parallel with the vertical direction.

In the heating and curing process, the dried or half-cured coated film 10A is heated, thereby imidizing the polyimide resin precursor included in the coated film 10A and forming the tubular member 10 (refer to FIG. 4).

The imidization is carried out by, for example, heating the coated film to from 250° C. to 450° C. (desirably from 300° C. to 400° C.), whereby the polyimide resin precursor is cured so as to become a polyimide resin. Examples of the heating time include from 30 minutes to 180 minutes.

Meanwhile, in the heating and curing process, a higher heating temperature shortens the time, which is preferable. In addition, it is also desirable to strike hot air or irradiate the energy of infrared rays during the heating. The heating temperature may be increased in stages, or increased at a constant rate.

Thereby, the tubular member 10 is formed on the core member 34 (refer to FIG. 4). In addition, the tubular member 10 is separated from the core member 34 so as to manufacture the tubular member 10.

The thickness of the formed tubular member 10 is, for example, in a range of from 30 μm to 150 μm.

The tubular member 10 is preferably used for an intermediate transfer belt, a paper transport belt, a fixing belt, and the like of an image-forming apparatus for which an electrophotographic method is used, such as a copier or a printer.

### EXAMPLES

Hereinafter, the exemplary embodiment will be described more specifically using examples, but the exemplary embodiment is not limited to the examples. Meanwhile, in the examples, the “parts” indicate “parts by mass.”

### Example 1

The tubular member 10 is manufactured through the following processes.

Firstly, a polyimide precursor solution composed of 3,3′,4,4′-biphenyl tetracarboxylic dianhydride and 4,4′-diaminodiphenyl ether (product name: U imide, manufactured by Unitika Limited, the solid content concentration is 18%, the solvent is N-methyl pyrrolidone, the viscosity at 25° C. is 50 P·s) is prepared as the polyimide precursor solution.

In addition, carbon black (product name: special black 4, manufactured by Evonik Industries AG, having a hydroxyl group and a carboxylic group as the acid group) is mixed as the conductive material having an acid group in the polyimide precursor solution in a solid content concentration of 80%, and, subsequently, is dispersed using an opposed impact-type disperser (manufactured by Geanus Co., Ltd., GeanusPY). During the dispersion, the temperature of the solution is maintained at 50° C. by adjusting the temperature of cooling water, and the dispersion is carried out by repeating impact operations five times. Thereby, a solution having a viscosity at 50° C. of 4 Pa·s and a viscosity at 25° C. of 20 Pa·s.

Next, a polyimide precursor solution (product name: U imide, manufactured by Unitika Limited, the solid content concentration is 18%, the organic solvent is N-methyl pyrrolidone, the viscosity at 25° C. is 100 Pa·s) is added in an amount so that 20 parts of carbon black is included in the dispersion fluid, and the resulting solution is mixed and stirred using a planetary stirring apparatus (manufactured by Aicohsha Manufacturing Co., Ltd., a capacity of 90 liters). In the planetary stirring apparatus, the minimum gap between the inner surface of the stirring tank and the stirring blade is 6 mm. In addition, in the apparatus, of the outer surface of a shape drawn by the rotating orbit of the stirring blade, 60% of the area of the surface facing the inner surface of the stirring tank has a gap with the inner surface of the stirring tank in a range of from 1 mm to 15 mm. The rotation speed of the stirring blade is 98 rpm, the orbit speed is 26 rpm, the solution is stirred for 2 hours with vacuuming so as to prepare a thermosetting solution. The temperature of the solution during the stirring is 40° C.

Meanwhile, the limiting viscosity of the prepared thermosetting solution is 10.2 ml/g.

For manufacturing of the tubular member, SUS304 cylindrical member having an outer diameter of 366 mm, a thickness of 6 mm, and a length of 900 mm is separately prepared, and the surface is coarsened into Ra 0.4 μm through a blast treatment using spherical alumina particles. In addition, a circular plate having a thickness of 8 mm, an outer diameter that is fit in an opening of the cylindrical member, and 4 vents having a diameter of 100 mm provided therein is manufactured using the same SUS material as a holding plate for holding the cylindrical member, fit and welded in the opening portion (both end surfaces in the width direction) of the cylindrical member. A silicone-based mold release agent (product name: SEPA COAT manufactured by Shin-Etsu Chemical Co., Ltd.) is coated on the surface of the cylindrical member, and a baking treatment is carried out at 300° C. for 1 hour. Thereby, the core member 34 on which the thermosetting solution is coated is manufactured.

Next, the thermosetting solution is coated on the manufactured core member 34 using the film-forming apparatus 40 as shown in FIG. 2. Meanwhile, the thermosetting solution prepared in the exemplary embodiment is fed into the storage unit 20 of the film-forming apparatus as shown in FIG. 2, and maintained at 20° C. for 3 days using the temperature-maintaining apparatus 32.

Meanwhile, in the film-forming apparatus 40, the mono pump 24 is connected to the storage unit 20 that stores the thermosetting solution manufactured in the present example (refer to 20A in FIG. 2), the thermosetting solution is ejected from the nozzle 26 at 20 ml/minute, and a film is formed from a location 40 mm away from one end of the prepared core member to a location 40 mm away from the other end (coated film-forming process). Meanwhile, as described above, the thermosetting solution 20A is stored at 15° C. for 3 days between after the dispersion and the coating on the core member 34 (a time period from after the completion of the dispersion to the coating on the core member). A 0.2 mm-thick stainless steel plate whose width and length are processed into 20 mm and 50 mm is used as the blade 29.

In addition, the core member 34 is rotated at 60 rpm in the rotating direction A, the ejected solution 20A is attached to the core member 34, then, the blade 29 is pressed to the surface of the core member, and moved in the shaft direction of the core member 34 (refer to the arrow B in FIG. 2) at a rate of 210 mm/minute. Thereby, the spiral line on the surface of the coated film 10A is lost. The blade 29 is separated 50 mm at the finishing end of the coated film 10A so as to prevent the blade from being in direct contact with the surface of the core member 34. Thereby, the coated film 10A having a film thickness of 500 μm is formed (coated film-forming process). This thickness corresponds to a film thickness of 80 μm of the tubular member 10 that has undergone the following heating and curing process. After that, the core member 34 is rotated at 10 rpm, fed into a drying apparatus of 170° C., and dried for 20 minutes. Thereby, the remaining amount of the solvent becomes 40% by mass, and the rotation of the core member 34 is stopped so that the coated film 10A which does not sag even in a vertical position is obtained. After that, the core member 34 is lowered from a rotating table, placed in a heating furnace in a vertical position (with the rotating shaft direction in the vertical direction), a heating reaction is caused for 30 minutes at 200° C., and for 30 minutes at 300° C., and drying of the remaining solvent and an imidization reaction are carried out at the same time (heating and curing process). After the core member is cooled to room temperature (25° C.), the heated and cured coated film 10A (tubular member 10) is taken away from the core member 34. Furthermore, the taken heated and cured coated film 10A (tubular member 10) is cut in the center, furthermore, unnecessary portions are cut away from both ends, and two tubular members 10 having a width of 360 mm are obtained. The film thickness of the tubular member 10 is measured using a dial gauge, and is 80 μm.

Similarly, the tubular member 10 is manufactured under the same conditions and using the same material except that the thermosetting solution is stored at 20° C. for 10 days from the preparation for being coated on the core member 34. Furthermore, similarly, the tubular member 10 is manufactured under the same conditions and using the same material except that the thermosetting solution is stored at 20° C. for 20 days from the preparation for being coated on the core member 34.

### Example 2

In Example 2, three kinds of tubular members (a tubular member manufactured by holding the thermosetting solution at 20° C. for 3 days, a tubular member manufactured by holding the thermosetting solution at 20° C. for 10 days, and a tubular member manufactured by holding the thermosetting solution at 20° C. for 20 days) are manufactured under the same conditions and using the same material as in Example 1 except the planetary stirring apparatus.

In the used planetary stirring apparatus (manufactured by Aicohsha Manufacturing Co., Ltd., a capacity of 90 liters), the minimum gap between the inner surface of the stirring tank and the stirring blade is 12 mm. In addition, in the present apparatus, of the outer surface of a shape drawn by the rotating orbit of the stirring blade, 30% or more of the area of the surface facing the inner surface of the stirring tank has a gap with the inner surface of the stirring tank in a range of from 1 mm to 15 mm.

Meanwhile, the limiting viscosity of the prepared thermosetting solution is 17.5 ml/g.

### Example 3

In Example 3, three kinds of tubular members 10 (a tubular member manufactured by holding the thermosetting solution at 20° C. for 3 days, a tubular member manufactured by holding the thermosetting solution at 20° C. for 10 days, and a tubular member manufactured by holding the thermosetting solution at 20° C. for 20 days) are manufactured under the same conditions and using the same material as in Example 1 except that the stirring blade is set to a rotation speed of 60 rpm and an orbit speed of 14 rpm in the stirring process using the planetary stirring apparatus.

Meanwhile, the limiting viscosity of the prepared thermosetting solution is 19.3 ml/g.

### Example 4

In Example 4, three kinds of tubular members 10 (a tubular member manufactured by holding the thermosetting solution at 20° C. for 3 days, a tubular member manufactured by holding the thermosetting solution at 20° C. for 10 days, and a tubular member manufactured by holding the thermosetting solution at 20° C. for 20 days) are manufactured under the same conditions and using the same material as in Example 1 except that the stirring time is set to one hour.

Meanwhile, the limiting viscosity of the prepared thermosetting solution is 18.1 ml/g.

### Example 5

In Example 5, three kinds of tubular members (a tubular member manufactured by holding the thermosetting solution at 20° C. for 3 days, a tubular member manufactured by holding the thermosetting solution at 20° C. for 10 days, and a tubular member manufactured by holding the thermosetting solution at 20° C. for 20 days) are manufactured under the same conditions and using the same material as in Example 1 except the stirring apparatus.

In the used stirring apparatus (manufactured by Aicohsha Manufacturing Co., Ltd., a capacity of 90 liters), the minimum gap between the inner surface of the stirring tank and the stirring blade is 6 mm. In addition, in the present apparatus, of the outer surface of a shape drawn by the rotating orbit of the stirring blade, 10% of the area of the surface facing the inner surface of the stirring tank has a gap with the inner surface of the stirring tank in a range of 1 mm to 15 mm.

Meanwhile, the limiting viscosity of the prepared thermosetting solution is 33.2 ml/g.

### Comparative Example 1

In Comparative Example 1, three kinds of tubular members (a tubular member manufactured by holding the thermosetting solution at 20° C. for 3 days, a tubular member manufactured by holding the thermosetting solution at 20° C. for 10 days, and a tubular member manufactured by holding the thermosetting solution at 20° C. for 20 days) are manufactured under the same conditions and using the same material as in Example 1 except the planetary stirring apparatus.

In the used stirring apparatus (manufactured by Aicohsha Manufacturing Co., Ltd., a capacity of 90 liters), the minimum gap between the inner surface of the stirring tank and the stirring blade is 18 mm.

Meanwhile, the limiting viscosity of the prepared thermosetting solution is 41.2 ml/g.

<Evaluation of Variation in the Volume Resistivity Due to Difference in the Holding Time of the Solution>

With regard to the tubular members manufactured in Examples and Comparative Examples, each of the volume resistivity of the tubular members manufactured by maintaining the thermosetting solutions for 3 days, the volume resistivity of the tubular members manufactured by maintaining the thermosetting solutions for 10 days, and the volume resistivity of the tubular members manufactured by maintaining the thermosetting solutions for 20 days is measured by the following measuring method, and the measurement results are shown in Table 1. A difference in the common logarithm values of the volume resistivity of the tubular members produced by maintaining the solutions for 3 days, the volume resistivity of the tubular members produced by maintaining the solutions for 20 days is obtained, and variation in the volume resistivity is evaluated. The evaluation results are shown in Table 1.

Meanwhile, the evaluation criteria are as follows.

Evaluation of Variation in the Volume Resistivity—

G1: in a case in which the difference in the common logarithm values of the volume resistivity of the tubular members produced by maintaining the solutions for 3 days and for 20 days is smaller than 0.3.

G2: in a case in which the difference in the common logarithm values of the volume resistivity of the tubular members produced by maintaining the solutions for 3 days and for 20 days is from 0.3 to 0.8.

G3: in a case in which the difference in the common logarithm values of the volume resistivity of the tubular members produced by maintaining the solutions for 3 days and for 20 days is larger than 0.8.

The volume resistivity of the tubular member is measured by the following measuring method.

Meanwhile, during the measurement of the volume resistivity, the tubular member 10 is cut open in the width direction so as to be formed into a tabular plate shape, the tabular plate-shaped tubular member 10 is interposed between the circular electrode 52 and the opposed electrode 54, and a voltage is applied between both electrodes, thereby measuring the volume resistivity.

(Measurement of the Volume Resistivity)

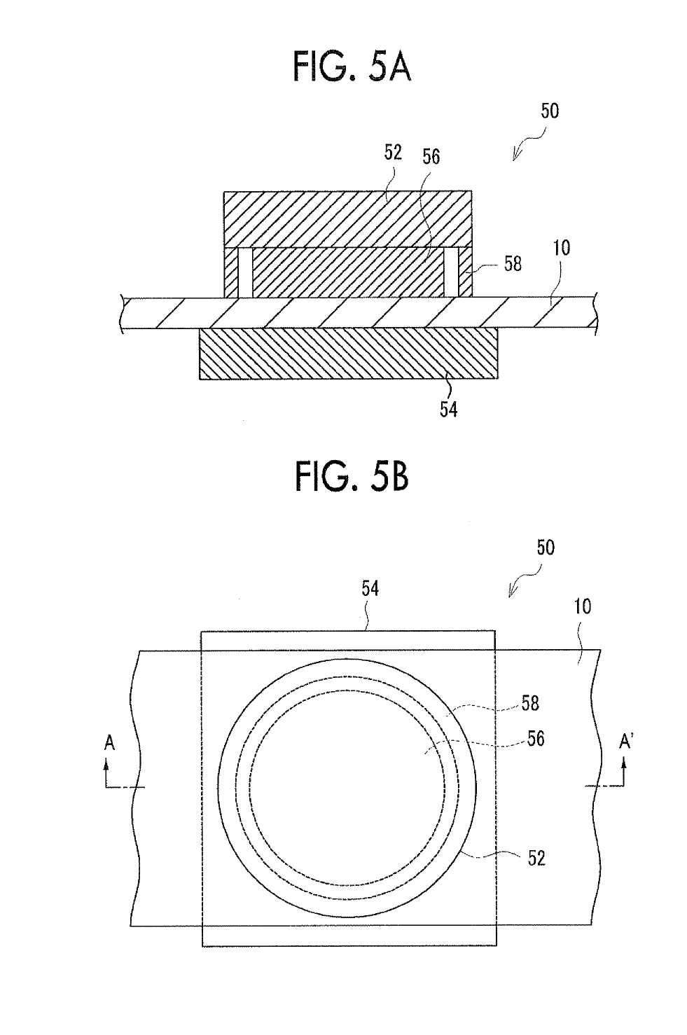

The volume resistivity of the tubular member is measured using the volume resistivity-measuring apparatus 50 as shown in FIG. 5 according to JIS K6911. In detail, as shown in FIG. 5, the volume resistivity-measuring apparatus 50 has the circular electrode 52 and the tabular plate-shaped opposed electrode 54. The circular electrode 52 has a columnar electrode unit 56 and a cylindrical electrode unit 58 that has an inner diameter larger than the outer diameter of the columnar electrode unit 56, and surrounds the columnar electrode unit 56 at a certain interval. The opposed electrode 54 is an electrode disposed so as to face the circular electrode 52 through the tubular member 10 of the measurement target.

Examples of the circular electrode 52 include a UR-100 probe of High Lester UP, manufactured by Mitsubishi Chemical Analytech Co., Ltd., and the like. In addition, examples of the opposed electrode 54 include an SUS304 tabular plate-shaped electrode. In addition, examples of an apparatus for measuring electric currents include R8340A digital ultrahigh resistance/minute electric current meter (manufactured by Advantest Corporation).

The volume resistivity-measuring apparatus 50 in the example uses a dual ring electrode-structured UR-100 probe (manufactured by Mitsubishi Chemical Analytech Co., Ltd.) as the circular electrode 52 and uses a 5 mm-thick stainless steel (SUS304) plate-shaped member (80 mm×500 mm) as the opposed electrode 54.

During measurement of the volume resistivity, the tubular member 10 is interposed between the columnar electrode unit 56 in the circular electrode 52 and the opposed electrode 54, and a weight having a mass of 2.0 kg±0.1 kg is mounted on the circular electrode 52 so that a uniform load is applied to the tubular member 10. In addition, the digital ultrahigh resistance/minute electric current meter is electrically connected to the circular electrode 52, and the measurement conditions are set to 30 seconds for the charging time, one second for the discharging time, and 500 V for the applied voltage.

At this time, the volume resistivity of the tubular member 10 of the measurement target is indicated as ρv, the thickness of the tubular member 10 is indicated as t (μm), the scanned value of the R8340A digital ultrahigh resistance/minute electric current meter is indicated as R, and the volume resistivity correction coefficient of the circular electrode 52 is indicated as RCF (V). Meanwhile, in a case in which a UR-100 probe of High Lester UP, manufactured by Mitsubishi Chemical Analytech Co., Ltd., is used as the circular electrode 52, the RCF (V) is 19.635 according to the “resistivity meter series” catalog of DIA Instrument Corporation. Therefore, the volume resistivity of the tubular member 10 is computed using the following equation (1). Equation (1): ρv[Ω·cm]=R×RCF (V)×(10000/t)=R×19.635×(10000/t).

According to the above measuring method, the volume resistivity of the tubular members that are manufactured by holding the thermosetting solutions prepared in the respective Examples and Comparative Examples for 3 days, 10 days, and 20 days is measured when a 500 V voltage is applied under conditions of 22° C. and 55% RH, the measurement results are shown in Table 1, and difference in the common logarithm values (log Ω/□) of the volume resistivity is also shown in Table 1.

Meanwhile, the absolute values of the difference between the common logarithm value A of the volume resistivity of the tubular member manufactured by holding the thermosetting solution for 3 days and the common logarithm value B of the volume resistivity of the tubular member manufactured by holding the thermosetting solution for 20 days (expressed as |A−B| in the table) are shown in Table 1.

As shown in Table 1, variation in the volume resistivity due to difference in the holding time of the thermosetting solution is suppressed in the tubular member manufactured in the example compared with the tubular member manufactured in the comparative example.

TABLE 1

| | Held for 3 day in the | | Held for 10 day in the | | Held for 20 day in the | | | | |
|---|---|---|---|---|---|---|---|---|---|
| | holding process | | holding process | | holding process | | | | |
| | | Common | | Common | | Common | | Evaluation | |
| | | logarithm | | logarithm | | logarithm | | of the | |
| | | value A of | | value of the | | value B of | | variation | |
| | Volume | the volume | Volume | volume | Volume | the volume | | in the | Limiting |
| | resistivity | resistivity | resistivity | resistivity | resistivity | resistivity | | volume | viscosity |
| | [Ω · cm] | [Log Ω · cm] | [Ω · cm] | [Log Ω · cm] | [Ω · cm] | [Log Ω · cm] | \|A-B\| | resistivity | [ml/g] |
| Example 1 | 2.82 × 10¹² | 12.45 | 3.31 × 10¹² | 12.49 | 3.31 × 10¹² | 12.52 | 0.07 | G1 | 10.2 |
| Example 2 | 2.14 × 10¹² | 12.33 | 2.88 × 10¹² | 12.46 | 3.55 × 10¹² | 12.55 | 0.22 | G1 | 17.5 |
| Example 3 | 1.62 × 10¹² | 12.21 | 1.91 × 10¹² | 12.28 | 2.88 × 10¹² | 12.46 | 0.25 | G1 | 19.3 |
| Example 4 | 2.00 × 10¹² | 12.3 | 2.45 × 10¹² | 12.39 | 3.09 × 10¹² | 12.49 | 0.19 | G1 | 18.1 |
| Example 5 | 7.76 × 10¹¹ | 11.89 | 2.19 × 10¹² | 12.21 | 2.75 × 10¹² | 12.44 | 0.55 | G2 | 33.2 |
| Comparative | 2.95 × 10¹¹ | 11.47 | 1.56 × 10¹² | 12.2 | 2.40 × 10¹² | 12.38 | 0.91 | G3 | 41.2 |
| Example 1 | | | | | | | | | |

From the above results, it is found that variation in the volume resistivity of the tubular member due to difference in the holding time of the thermosetting solution is suppressed in the exemplary embodiment compared with the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method of manufacturing a thermosetting solution comprising:
preparing a solution having a conductive material having an acid group dispersed in the solution;
preparing a polyimide precursor solution; and
mixing the solution having the conductive material dispersed therein and the polyimide precursor solution, and stirring the mixed solution using a stirring tank in which a stirring blade is disposed and the minimum gap between the inner surface of the stirring tank and the stirring blade is from about 1 mm to about 15 mm.

2. The method of manufacturing a thermosetting solution according to claim 1,
wherein, of the outer surface of a shape drawn by the rotating orbit of the stirring blade, 30% or more of the area of the surface facing the inner surface of the stirring tank has a gap with the inner surface of the stirring tank in a range of from about 1 mm to about 15 mm.

3. A method of manufacturing a tubular member comprising:
coating the thermosetting solution manufactured by the method of manufacturing a thermosetting solution according to claim 1 on a core member so as to form a coated film of the thermosetting solution, and
heating and curing the coated film so as to produce a tubular member.

4. A method of manufacturing a tubular member comprising:
coating the thermosetting solution manufactured by the method of manufacturing a thermosetting solution according to claim 2 on a core member so as to form a coated film of the thermosetting solution, and
heating and curing the coated film so as to produce a tubular member.

5. The method of manufacturing a tubular member according to claim 3,
wherein the limiting viscosity of the thermosetting solution is about 40 ml/g or less.

6. The method of manufacturing a tubular member according to claim 4,
wherein the limiting viscosity of the thermosetting solution is about 40 ml/g or less.
